(19) United States
(12) Patent Application Publication
(10) Pub. No.: US 2008/0308379 A1
(43) Pub. Date: Dec. 18, 2008

(54) Clutch unit

(75) Inventors: Mathieu Jordan, Strasbourg (FR); Karl-Ludwig Kimmig, Ottenhofen (DE); Phillipe Mih, La Wantzenau (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/156,125

(22) Filed: May 29, 2008

Related U.S. Application Data
(63) Continuation of application No. PCT/DE2006/001920, filed on Nov. 2, 2006.

(30) Foreign Application Priority Data
Nov. 29, 2005 (DE) 10 2005 057 233.2

(51) Int. Cl. F16D 13/75; F16D 13/71; F16D 13/58

(52) U.S. Cl. 192/70.251

(57) ABSTRACT

A clutch unit having at least one friction clutch including a pressure disk joined to a housing in a rotationally fixed but axially displaceable manner. A lever system that can pivot axially is arranged between the housing and the pressure disk and can be impinged upon by an actuation device to engage the clutch. An adjusting device that at least partially compensates wear and tear of the friction lining of the clutch engages between the lever system and the housing. The lever system is axially supported on the housing by a rotatable adjusting ring and can be impinged upon in an axial manner in the direction of the adjusting ring by spring elements to produce an axial supporting force that is opposite to the clutch closing pressure applied to the lever system. A force-path characteristic is produced that reduces at least in the working area, wherein the spring elements are deformed for the at least partial wear and tear compensation.

The invention relates to clutch units which consist of at least one friction clutch comprising a pressure disk, which is joined to a housing in a rotationally fixed manner but with limited axial displacement capability; a lever system which can pivot in an axial direction is provided between housing and pressure disk and can be acted on by an actuating mechanism to engage the clutch; an adjusting device that compensates at least partially for the wear on the friction linings of a clutch plate operates between the lever system and the housing; in addition, the lever system is supported axially on the housing through an adjusting ring that is rotatable relative to the housing, and can be acted on by spring means axially in the direction of the adjusting ring, the spring means producing a resulting axial supporting force that is axially opposite in direction to the clutch engaging force that is introducible into the clutch system.

Such clutch units with a single clutch or two clutches have been proposed for example by DE 10 2004 018 377 A1.

Clutches with automatic adjustment have also been proposed for example by DE 29 16 755 A1 und DE 35 18 781 A1; in those clutches a force that remains practically constant is supposed to be applied to the pressure plate by the compression spring.

The object of the present invention was to design clutch units of the type named at the beginning in such a way that they require only a small construction space, at least in the axial direction. Another object of the present invention was to also keep the actuation path of the actuating element that acts on the lever system and introduces the engaging force into the clutch short and essentially constant over the life of the clutch. Furthermore, a clutch unit designed according to the invention should ensure optimized functionality and a long service life, as well as being economical to produce.

The aforementioned tasks or goals are solved or achieved in part by the fact that the lever system has axial spring properties which cause it to be pushed in the direction of a position with the shape of a truncated cone, which corresponds to the disengaged state of the friction clutch; over the pivot travel or pivot angle necessary to engage the friction clutch the lever system exhibits a rising force-travel spring characteristic, and the spring means acting axially on this lever system produce a force-travel characteristic that declines, at least in the working range over which the spring means are deformed in order to compensate at least partially for the wear. It is useful if the spring means that apply an axial supporting force on the lever system have a declining force-travel characteristic over their entire working range which is necessary over the life of the friction clutch. Hence the axial spring force exerted on the lever system by the spring means declines over the disengagement path of the friction clutch; that is, it becomes smaller.

The aforementioned spring characteristic of the lever system can be at least approximately linear over the working range that is necessary for the total life of the friction clutch. However, the usable spring characteristics can also exhibit curvature, at least in some areas.

The lever system can be formed in an advantageous way by a plurality of levers oriented radially in a ring-shaped arrangement. In order to give such a lever system the necessary axial spring properties, the individual levers can be coupled with each other; connecting segments formed in a single piece with the levers can be provided for the coupling. These connecting segments, together with the levers, can form a ring-shaped energy storage element. However, the connecting segments provided between the adjacent levers can also follow a loop-shaped pattern in a radial direction. The desired spring characteristic for the lever system can thus be realized through appropriate design of the connecting segments present between the individual levers. In addition to or as an alternative to the connecting segments, a ring-like spring means, for example in the nature of a diaphragm spring, may be utilized, which is connected at least axially to the individual levers.

The lever system can advantageously be built into the friction clutch in such a way that it can pivot radially in the manner of a one-armed lever on the outside on a ring-shaped rolling-contact support carried by the adjusting ring. To this end, the lever system is pressed axially against the rolling-contact support by the aforementioned spring means. The rolling-contact support can be made in a single piece with the adjusting ring. However, the rolling-contact support can also be formed by an additional part, ring-shaped for example, which is supported by the adjusting ring.

To build the adjusting device, it can be useful if the adjusting ring is supported on the clutch housing by means of a ramp system in a ring-shaped arrangement. The ramp system advantageously has a plurality of ramps extending in a circumferential direction and rising in the axial direction. The gradient angle of the ramps is preferably designed so that self-arresting is available in the ramp system, so that the ramps can be prevented from sliding down. If necessary, the ramps can be provided with a certain roughness or with slight profiling along their extent, which make it possible for the ramps to shift in the direction of adjustment but prevent them from sliding down. The adjusting function of the ramp system can be ensured in a simple manner by means of at least one energy storage element that braces the ramp system in the direction of adjustment.

The axial pressure on the lever system in the direction of the pivot support by means of the spring means can be advantageously applied radially within the adjusting ring that carries the pivot support. The spring means that supply the axial support force for the lever system can be braced indirectly or directly on the lever system. Advantageously, these spring means can include an element in the nature of a diaphragm spring, which is clamped operationally between the housing and the lever system. A diaphragm-spring-like element of this sort can be clamped axially between the housing floor and the lever system. However, it can also be effective to provide such a diaphragm-spring-like element on the side of the lever system facing away from the housing floor, in which case it can be useful if there are means of support present which are connected to the housing, penetrate the lever system axially, and serve as axial support for the diaphragm-spring-like element.

Furthermore, the spring means can include spring elements that are braced axially between the housing and the pressure disk. Such spring elements can be formed for example by so-called leaf springs. Such leaf springs are firmly connected to the housing by one end and firmly connected to the pressure disk by the other end. Such spring elements braced between the housing and the pressure disk (such as leaf springs) can ensure the transfer of torque between housing and pressure disk on the one hand, and on the other hand can ensure axial displacement of the pressure disk during operation of the clutch. Preferably, these spring elements are installed under tension in such a way that they press or force the pressure disk axially in the direction of disengagement of the clutch.

For the functioning of the clutch system or of the friction clutch, it can be especially advantageous if a lining resiliency is present between the back-to-back friction linings of the clutch plate. Such a lining resiliency causes an additional axial bracing force to be exerted on the lever system in the direction of the pivot support as soon as the friction linings are moved axially toward each other by the pressure disk, which causes the plate spring to come under tension.

For the functioning of the adjusting device, it is especially advantageous if at least approximately at the time the pressure disk comes into contact with the adjacent friction lining of the clutch plate, and when there is no wear on the friction lining, the forces acting on the lever system in the direction of engagement are in equilibrium with the resulting spring force acting axially on the lever system opposite the direction of engagement, which pushes the lever system in the direction of the rolling-contact support carried by the housing. This resulting spring force is at least produced by at least one diaphragm-spring-like component clamped between the housing and the lever system, and in addition by leaf springs braced between the pressure disk and the housing and if necessary by an axial force produced as a result of the bracing of the pressure disk on the adjacent friction lining by the lining resiliency.

Advantageously, the clutch unit can be constructed in such a way that the compensation for wear by the adjusting device takes place at least substantially during the disengaging phase of the clutch unit. The adjusting device is preferably designed and coordinated with the other components of the clutch unit or of the friction clutch in such a way that the adjustment for wear takes place at least approximately when the lining resiliency is fully relaxed, during a disengagement phase of the clutch unit or of the friction clutch.

Additional benefits, both in function and in design, will be explained in greater detail in conjunction with the following description of the figures.

The figures show the following:

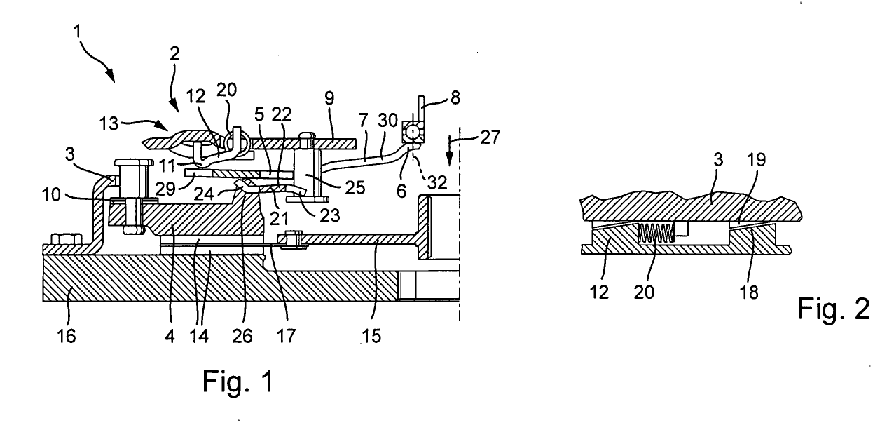

FIG. 1: a half-sectional view through a friction clutch designed according to the invention,

FIG. 2: a detail of the adjusting device in FIG. 1,

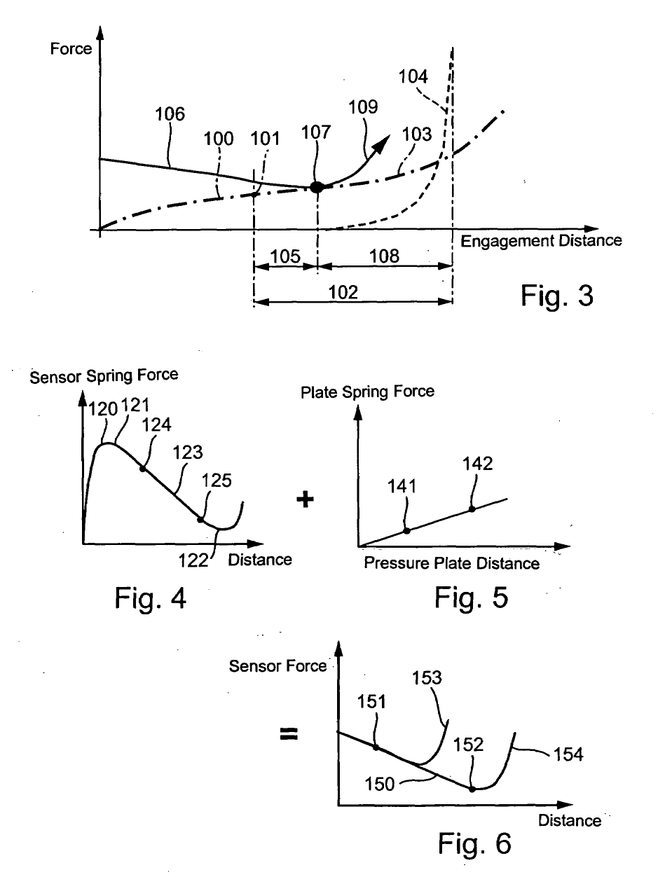

FIGS. 3 through 7: diagrams with various characteristic curves, from which the interaction of the individual spring elements and adjusting elements of a friction clutch designed according to the invention can be seen, and

FIG. 8: a dual-clutch unit with a friction clutch according to FIG. 1.

The clutch unit 1 depicted in FIG. 1 in a half-sectional and schematic view includes at least one friction clutch 2. The friction clutch 2 has a housing 3, and a pressure disk 4 that is connected to it in a rotationally fixed manner but with limited axial movability. Situated between the pressure disk 4 and the housing 3 is a lever element 5, which has changeable conicity and here exhibits a springing or resiliency as the clutch 2 is disengaged. To engage the clutch 2, the radially inner tips 6 and the lever 7 that forms the lever element 5 are acted on by an actuating element 8 which at least substantially introduces the engaging force into the clutch 2. The actuating element 8 advantageously includes a roller bearing and forms a component of an actuating system, which can be designed as a pneumatic, hydraulic, electrical or mechanical actuating system or has a combination of the aforementioned actuating options, i.e. which is designed for example as an electrohydraulic actuating system. The lever element 5 is formed in an advantageous manner by a large number of levers 7 provided in a ring-shaped arrangement, which are connected with each other in an advantageous manner in the circumferential direction. The connections present between the individual levers 7 can be designed in a single piece with the levers, or can be formed by an additional spring element, for example ring-shaped diaphragm springs, connected to the levers 7. The connections present between the individual levers 7 are efficiently designed in such a way that the lever element 5 has an axial resiliency which ensures the possibility of a change in the conicity of the lever element 5. Such lever elements have been proposed for example by DE 103 40 665 A1, EP 09 92 700 B1, DE 199 05 373 A1 and EP 14 52 760 A1.

In the exemplary embodiment depicted, lever element 5 is situated axially between the floor 9 of housing 3 and pressure disk 4.

Between pressure disk 4 and housing 3 there are spring elements 10, which are designed as so-called leaf springs in the exemplary embodiment depicted. Spring elements 10 ensure the transmission of torque between housing 3 and pressure disk 4. Furthermore these spring elements 10, designed as leaf springs, make it possible to shift pressure disk 4 laterally relative to housing 4. The spring elements 10 have a defined axial pre-tensioning, which ensures that pressure disk 4 is pressurized in the direction of disengagement of clutch 2. That ensures that pressure disk 4 is always pushed axially in the direction of lever element 5 by the spring elements 10. Under normal operating conditions this effect of the spring elements 10 causes lever element 5 to be pushed against a ring-shaped support 11 carried by housing 3. Ring-shaped support 11 is carried or formed by a ring-shaped component 12, which is a component of an adjusting device 13, by means of which the wear that occurs at least on the friction linings 14 of a clutch plate 15 can be at least partially compensated for automatically. The friction linings 14 are clamped between pressure disk 4 and the opposing pressure plate 16 when clutch 2 is engaged. Housing 3 is rigidly connected to opposing pressure plate 16. Opposing pressure plate 16 can be a component of a clutch unit which has two clutches. Such clutch units can be used for example in combination with so-called power-shift transmissions. Opposing pressure plate 16 can also be connected directly to the output shaft of an engine, however.

Between the friction linings 14 situated back-to-back, there is preferably a so-called lining resiliency 17. Such lining resiliencies have become known for example through DE 198 57 712 A1, DE 199 80 204 T1 and DE 29 51 573 A1.

As FIG. 2 shows schematically, ring-shaped component 12 designed as an adjusting ring has ramps 18, which are supported on opposing ramps 19 carried by the housing 3. In a circumferential direction, adjusting ring 12 is acted on by springs 20, which are braced between housing 3 and adjusting ring 12. The opposing ramps 19 can be formed directly in an advantageous manner by ramps formed in the area of the housing floor 9.

Additional details relating to the manner of function of an adjusting device 13, the design options for the ramps 18 and opposing ramps 19 and the design and arrangement of the springs 20 can be obtained from DE 42 39 291 A1, DE 42 39 289 A1, DE 43 22 677 A1 and DE 44 31 641 A1.

Through the use of a lining resiliency 17, it is possible to ensure positive build-up of the transmittable torque when engaging friction clutch 2.

Lever element 5 is pressured additionally in the direction of engagement of the clutch 2 by a spring element 21, which is operationally clamped axially between housing 3 and lever element 5. In the depicted exemplary embodiment, this spring element 21 is formed by a diaphragm spring, which in the embodiment depicted in FIG. 1 has a ring-shaped basic body 22 that is supported radially on the inside on spacing bolts 25 by means of extensions 23 and radially on the outside on lever element 5 by means of extensions 24. The spacing bolts 25 are connected to housing 3, and extend axially between adjacent levers 7. Pressure disk 4 has individual cams 26 distributed in the circumferential direction, between which the extensions 24 are received circumferentially. The cams 26 come under pressure from lever element 5, at least when clutch 2 is being engaged.

As can be seen from FIG. 1, when lever element 5 is pivoted, the levers 7 are pivoted in the direction of engagement 27 around the ring-shaped support 11 in the manner of a one-armed lever. This pivoting around the ring-shaped support 11 is ensured by the fact that the resulting bracing force exerted axially on the lever element 5 at least by the leaf springs 10 and the diaphragm-spring-like spring element 21 axial is greater than the engaging force to be introduced in the direction of arrow 27 in the area of the lever tips 6 through actuating element 8 to engage the clutch 2. In the aforementioned ratio of forces it is also necessary to take account of the axial force produced through the ramp system 18 and 19 by the springs 20, which is exerted on lever element 5 through ring-shaped component 12.

The individual axial forces acting on lever element 5 are adjusted to each other in such a way that it is impossible to shift the adjusting device 13 as long as no wear occurs at least on the friction linings 14. The relationship between the individual spring forces and actuating forces will be described in further detail below.

It can also be seen from FIG. 1 that as soon as the friction linings 14 begin to be clamped between pressure disk 4 and opposing pressure disk 16 during an engagement phase of clutch 2, the axial force then produced by the lining resiliency 17 acts additionally in an axial direction on lever element 5.

The aforementioned force ratios or force designs ensure that, as already mentioned, when lever element 5 is pivoted it remains in contact with ring-shaped support 11 and is pivoted around this ring-shaped support 11 in the manner of a one-arm lever. That causes pressure to be applied on pressure disk 4 in the direction of engagement through the cams 26, while at the same time pressure is also applied to the diaphragm-spring-like spring element 21, and the latter is deformed elastically according to the lever ratios present between the diameters of support and pressurization. During the elastic deformation, the pivoting of spring element 21 takes place here in the area of the tips of the extensions 23, which are supported on the pins 25. As mentioned earlier, if there is no wear the resulting spring force acting axially on lever element 5 contrary to the direction of engagement 27 is always greater over the entire engagement distance of clutch 2 than the engaging force introduced in the area of the lever tips 6. That ensures that lever element 5 always exerts a certain axial force on ring-shaped component 12. This prevents unintended twisting and thus repositioning in the area of adjusting device 13.

The interaction of adjusting device 13 with at least spring element 21 and the leaf spring elements 10 forms a wear compensation device which, when wear occurs at least on the friction linings 14, brings about at least partial compensation of that wear through axial tracking by the ring-shaped support 11. The force ratios between the various spring elements acting on lever element 5 and lever element 5 itself are preferably adjusted to each other in such a way that the necessary actuating travel in the direction of arrow 27 in the area of the lever tips 6 to engage the clutch 2 remains practically constant, while the axial position of the lever tips 6 remains practically constant with friction clutch 2 engaged and disengaged. That ensures that actuating element 8 also operates over practically the same axial actuation distance over the entire life of the friction clutch. This manner of functioning of the wear compensating device is determined by appropriate design of the spring elements acting on lever element 5, as well as the spring properties of lever element 5 and the lever ratios that exist at lever element 5 between the ring-shaped supporting, spring pressurizing and actuation zones.

As can be seen from FIG. 1, lever element 5 can have a basic area 28 that works like a diaphragm spring and has a closed circumference, from which extensions 29, 30 extend radially outward and inward.

The manner of functioning of the friction clutch 2 described above will now be explained in greater detail in conjunction with the characteristics recorded in the diagrams in FIGS. 3 through 7.

The conditions shown in FIG. 3 correspond to the new condition of the installed friction clutch 2 after its first actuation, i.e. without any wear having occurred.

Line 100 corresponds to the axial force to be exerted on the lever tips 6 to change the conicity of the resilient lever element 5, namely when this lever element 5 is deformed between two ring-shaped supports whose radial separation corresponds to the radial separation between the ring-shaped support 31 formed by spring element 21 and the ring-shaped pressurization zone 32 on the tongue tips 6 for the actuating element 8. The operating point assumed by lever element 5 in new condition and after the first actuation of friction clutch 2 corresponds to point 101. This operating point 101 determines the angle of the installation position of lever element 5 with a new friction clutch 2 ready for operation. From FIG. 3 it can be seen that lever element 5 has a spring characteristic that rises over the engagement distance 102, i.e. that is progressive. The force curve 103 over the engagement path 102 can be adjusted to the particular application through appropriate design of the resilient lever element 5.

The dashed line 104 represents the axial spreading force provided by the lining resiliency segments 17, which acts between the two friction linings 14. This axial spreading force works against the axial engaging force introduced through lever element 5 onto pressure disk 4. This effect occurs as soon as the friction linings 14 begin to be clamped between the friction surfaces of pressure disk 4 and opposing pressure plate 16. The latter is the case after sub-segment 105 of the engagement distance 102 has been covered by pressure disk 4 in engagement direction 27. Sub-section 105 corresponds to the free clearance that is necessary in order to ensure a certain axial play for the friction linings 14 between the friction surface of pressure disk 4 and opposing pressure plate 16. Such play is necessary in order to prevent the transmission of excessive drag torque to the clutch plate 15 with clutch 2 disengaged, since such drag torque would at least degrade the shiftability of the transmission.

Line 106, which extends beyond control point 107 as a dashed line, represents the resulting curve of the force that is produced by the superimposition or addition of at least the force curves of the leaf springs 10 and of the spring element 21, in this case in the nature of a diaphragm spring. The forces produced at least by the leaf spring elements 10 and spring element 21 act axially contrary to the engaging force introduced into lever element 5 in the area of the lever tips 6 by means of actuating element 8.

It can be seen from FIG. 3 that the resulting force curve according to line 106 has a characteristic pattern that declines as the tensioning or deformation of the spring elements 10 and 21 increases. It is apparent that because of the chosen patterns for lines 100 and 106 these intersect in the area of control point 107 and the force relationship between the two lines 100 and 106 is reversed, with the result that after passing the control point 107 the axial supporting force exerted at least by spring elements 10 and 21 on lever element 5 becomes smaller than the engaging force applied to deform lever element 5 in the area of the lever tips 6.

As mentioned above, after the sub-segment 105 has been traversed the lining resiliency 17 also takes effect, with the result that when sub-segment 105 has been passed in the direction of engagement 107, the actuating force necessary to pivot lever element 5 increases until the end of the engagement distance. This increase is portrayed by the line segment 109 extending over the second sub-segment 108 of engagement path 102.

It can be discerned on the basis of the characteristic lines depicted in FIG. 3 that on both sides of the control point the forces acting axially on lever element 5 contrary to arrow 27 are greater than the forces represented by the force curve 103, which are exerted in the area of the lever tips 6 in the direction of arrow 27 to engage friction clutch 2. That ensures that lever element 5 always exerts an axial force on the ring-shaped support 11 or ring-shaped component 12, which prevents twisting of the ring-shaped component. In the area of control point 107 there is at least an axial equilibrium present between the aforementioned forces, as long as there is no wear, so that then as well no unwanted displacement can occur within friction clutch 2.

In connection with FIG. 1 it is also understandable that when friction clutch 2 is engaged, or closed, spring elements 10 and 21 are deformed elastically or resiliently, this deformation being dependent on the axial displacement of pressure disk 4 and the pivoting motion of lever element 5 in relation to the ring-shaped support 11.

The principles of how the resulting force curve according to lines 106 and 109 in FIG. 3 comes about will now be explained briefly on the basis of FIGS. 4 through 6.

FIG. 4 depicts a possible spring characteristic 120 of a diaphragm-spring-like spring element corresponding to spring element 21. In the depicted exemplary embodiment, the depicted characteristic 120 has a typical diaphragm spring characteristic, with a force maximum 121 and a force minimum 122. The characteristic curve 120 depicted here has a practically linear area 123 between the force maximum 191 and the force minimum 122. This area 123 could also have a different pattern, however, such as a slightly arched course for example.

The tension state of diaphragm-spring-like spring element 21 with friction clutch 2 installed and ready to operate corresponds to point 124 in FIG. 4. Since the friction linings 14 are subject to wear over the life of friction clutch 2, as mentioned earlier, (for example on the order of 2 to 3 mm in all), the tension state of spring element 21 changes. With maximum wear, in the depicted exemplary embodiment the spring element 21 should be in a tension state that corresponds to point 125. Thus it is discernable from FIG. 4 that, when viewed over the life of friction clutch 2, the axial force exerted by spring element 21 on lever element 5 decreases.

FIG. 5 shows the spring characteristic 140 that is generated in the depicted exemplary embodiment by the leaf spring elements 10. The leaf springs are designed here so that they produce a practically linear force characteristic. The leaf spring elements 10 are installed in such a way that with friction clutch 2 installed and ready for use they exert an axial force on pressure disk 4 that corresponds to point 141. As can be discerned in connection with FIG. 1, pressure disk 4 shifts axially relative to housing 3 as the wear increases on the friction linings 14. This shifting causes increased tensioning of the leaf spring elements 10, so that over the life of friction clutch 2 they exert an increasing axial force on pressure disk 4 and thus through it also on lever element 5. When maximum wear is present, the leaf spring elements 10 have an operating point that corresponds to point 142 in FIG. 5. FIG. 6 depicts the resulting force curve pattern 150, which comes about through superimposition, i.e. addition of the linear path 123 of characteristic 120 and spring characteristic 140. It is evident that this resulting force pattern 150 follows a descending course over the life of friction clutch 2. The points on the characteristic curve that correspond to the new state and to the worn out condition of friction clutch 2 are identified as 151 and 152.

The operating points 124, 125, 141, 142, 151 and 152 contained in FIGS. 4, 5 and 6 correspond to those operating points of the various spring elements 10 and 21 that are present for an installed, functionally ready, disengaged clutch 2.

FIG. 6 shows still rising characteristic ranges 153, 154, which take account of the effect of the lining resiliency 17 that becomes effective after a defined engagement distance (for example: 105 according to FIG. 3)

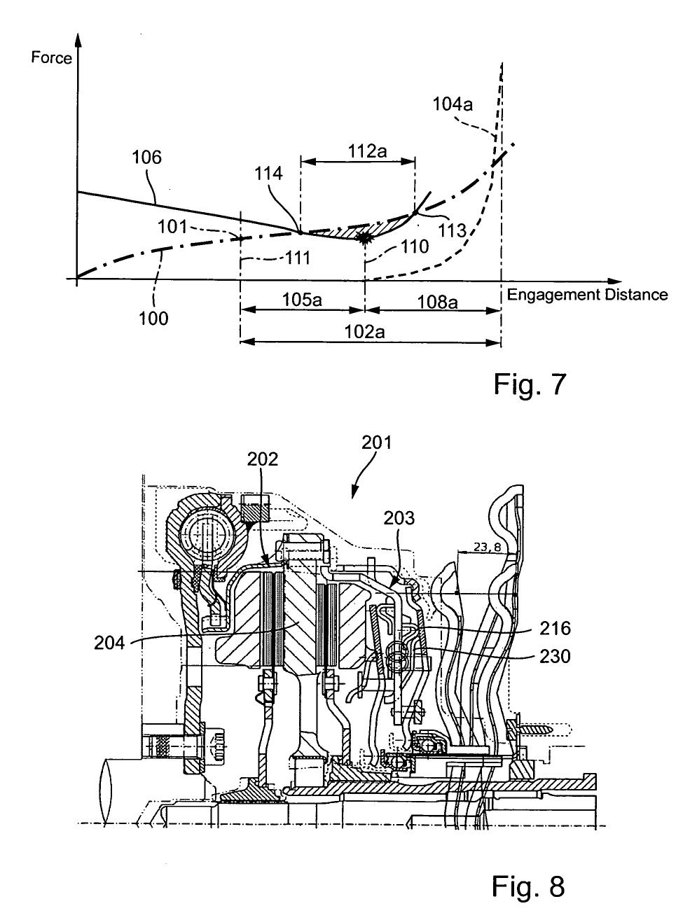

The principle that brings about an adjustment in adjusting device 13, or in the wear compensating device that includes it, will now be explained on the basis of FIG. 7. Let it be noted beforehand that the travel ranges or changes in these travel ranges adduced to explain the manner of functioning of an adjusting cycle, as well as the changes that occur in forces, are exaggerated in order to make them easier to understand. In reality the adjustments take place in relatively small steps, and the operating or adjustment points are also subject to certain variations due to hysteresis effects and interference forces present in the clutch system as a whole, for example due to vibrations, so that they fall within a certain bandwidth.

The diagram according to FIG. 7 is based on the assumption that a certain amount of wear has occurred on the friction linings 14 during engagement of the friction clutch 2. That enlarges the pivot angle of lever element 5 by an amount that depends on this wear. This is evident from the fact that the engagement path 102a in FIG. 7 is longer than the engagement path 102 according to FIG. 3; in the ideal case the difference is equivalent to the wear that has occurred at least on the friction linings 14. Assuming that the elastic properties of the lining resiliency 17 have remained the same, the sub-range 108a over which this lining resiliency 17 is effective is the same as sub-range 108 in terms of size. Because of the wear, however, the sub-range 105a between the path 110 starting from which there is no longer any effect from the lining resiliency 17 on the pressure disk 4 when disengaging clutch 2 and the path 111 which corresponds to the installation location of lever element 5 with clutch 2 disengaged, has become greater. As can be discerned in connection with FIGS. 3 and 7, this increase in the path 105a causes the holding force that must be applied to pivot lever element 5 in the area of the lever tips 6 when opening the clutch 2 by a certain distance 112a to be greater than the resulting force (or force pattern) which is then present over this path 112a, and which impinges axially on lever element 5 in the direction of ring-shaped support 11. The area resulting from the overlapping of the two characteristic curves 106 and 100 is shaded in FIG. 7.

Because of the force relationships that arise as wear occurs on the friction linings 14 when friction clutch 2 disengages, lever element 5 first pivots contrary to the direction of arrow 27 in FIG. 1 around ring-shaped support 11 in the manner of a one-armed lever, until the point identified as 113 in FIG. 7 has been reached. As the pivoting motion of lever element 5 in the direction of disengagement continues, lever element 5 now pivots around ring-shaped support 31 in the manner of a two-armed lever. This pivoting is due to the fact that the axial force acting on lever element 5 in the direction of arrow 27, which is produced in particular by the actuating force introduced in the area of the lever tongues, is greater than the resulting supporting force for lever element 5, which is contrary to arrow 27. This pivoting of lever element 5 around ring-shaped support 31 continues at least approximately until, upon passing point 114, the resulting axial supporting force acting on lever element 5 contrary to arrow 27 becomes greater than the force needed in the area of the lever tongues 6 to deform or support lever element 5.

During the aforementioned operating phase, in which lever element 5 is pivoted around ring-shaped support 31 in the manner of a two-armed lever, the load on adjusting ring 13 is relieved, so that the latter can follow the pivoting motion of the outer extensions 29 or the outer area of lever element 5. That results in at least a certain adjustment for the wear occurring on the friction linings 14. The magnitude of the adjustment depends on the lever ratios present at lever element 5, which are prescribed by the diameter of ring-shaped support 11, ring-shaped support 31 and ring-shaped exposure area 32. The axial adjustment of support 11 can be greater than the axial wear which has occurred on the friction linings 14.

The aforementioned lever ratios, as well as the forces acting on lever element 5 which determine the pivoting and shifting of the latter, and the spring properties of lever element 5, are preferably coordinated with each other in such a way that the tongue tips 6 remain in practically the same axial position over the life of friction clutch 2 when the latter is disengaged. This means that although the tongue tips 6 maintain a practically constant axial position in relation to the clutch housing 3, the outer area of lever element 5 (in the area of ring-shaped support 11) must be shifted. This is necessary in order to ensure that despite the wear occurring on the friction linings 14 and the associated axial shifting of pressure disk 4, the requisite actuating travel to engage the friction clutch remains at least approximately constant in the area of the lever tips 6. Because of the kinematics or pivoting relationships for lever element 5 present in the design according to FIG. 1, the axial adjusting travel which this requires in the area of ring-shaped support 11 is greater than the amount of axial wear on the friction linings 14, and in fact corresponding to the existing lever ratios. These lever ratios are determined mainly by the distance between the ring-shaped support 11 and the exposure diameter 32 on the one hand, and the radial distance between the ring-shaped support 31 and the exposure diameter 32 on the other hand. The target, according to which the lever tips 6 are supposed to maintain at least a constant axial position over the life of the friction clutch, specifies that the lever element 5 shall change its tension state at least when friction clutch 2 is disengaged, which is accomplished by adjusting the ring-shaped support 11 accordingly. This change also causes a change in the in the tension state of spring elements 10 and 21 when the friction clutch is disengaged. This is due to the fact that these spring elements 10 and 21 are supported axially either indirectly or directly on lever element 5, which in turn assumes a tensioned position that changes over the life of the friction clutch.

The aforementioned changes to the tension state of at least the spring elements 10 and 21 and of lever element 5 cause lever element 5 to relax by a certain amount over the life of the friction clutch, whereas spring elements 10 and 21 undergo an increase in their tensioning. That means that the resulting bracing force for lever element 5 produced at least by spring elements 10 and 21 decreases with increasing wear on the friction linings 14, as can be discerned from the various diagrams in FIGS. 3 through 7. The force pattern needed to pivot lever element 5 in the area of the lever tips 6 also decreases as a result of the aforementioned relaxation of lever element 5.

The spring characteristics of the individual elements, in particular of components 5, 10 and 21, are designed so that the previously described adjustment principle remains intact over the life of the friction clutch due to the existing force relationships, despite the aforementioned shifts or changes in the operating points or working ranges of these spring elements.

Through appropriate design, at least of the spring elements 10 and 21, it is also possible to produce a resulting force pattern that has a substantially constant force to compensate for the wear on the friction lining, at least over the axial adjustment path of pressure disk 4. Such a segment of the force curve is substantially parallel to the abscissa. In a design of this sort, the resulting axial shift of lever element 5 can take place in such a way that lever element 5 always has a constant conicity, at least when clutch 2 is in the engaged state and possibly also when it is in the disengaged state.

FIG. 8 shows a double clutch unit 201, which has two friction clutches 202 and 203 that are situated on both sides of a plate 204 designed as an opposing pressure disk. In the depicted exemplary embodiment, friction clutch 203 is designed with the functional arrangement of its individual components as described in connection with the preceding figures.

### REFERENCE NUMERAL LIST

1 clutch unit
2 friction clutch
3 housing
4 pressure disk
5 lever element
6 inner tips
7 lever
8 actuating element
9 housing floor
10 spring elements
11 ring-shaped support
12 adjusting ring
13 adjusting device
14 friction linings
15 clutch plate
16 opposing pressure plate
17 lining resiliency
18 ramps
19 opposing ramps
20 springs
21 spring element
22 ring-shaped basic body
23 extension
24 extension
25 spacing bolt
26 cam
27 arrow
28 closed basic area
29 extension
30 extension
31 ring-shaped support
32 ring-shaped exposure area
100 line—axial force to change the conicity
101 operating point
102 closing distance
102a engagement distance
103 force pattern
104 dashed line—axial spreading force
105 sub-range
105a sub-range
106 line—resulting force pattern
107 control point
108 second sub-range
108a sub-range
109 line segment
110 path
111 path
112a travel distance
113 pivoting
114 point
120 spring characteristic
121 force maximum
122 force minimum
123 linear area
124 tension state
125 tension state
140 spring characteristic
141 operating point
142 operating point
151 characteristic point
152 characteristic point
153 rising characteristic point
154 rising characteristic point

1: A clutch unit consisting of at least one friction clutch comprising a pressure disk, which is joined to a housing in a rotationally fixed manner but with limited axial displacement capability; a lever system which can pivot in an axial direction is provided between housing and pressure disk and can be acted on by an actuating mechanism to engage the clutch; an adjusting device that compensates at least partially for the wear on the friction linings of the clutch plate operates between the lever system and the housing; in addition, the lever system is supported axially on the housing through an adjusting ring that is rotatable relative to the housing, and is acted on by spring means axially in the direction of the adjusting ring, the spring means producing a resulting axial supporting force that is axially opposite in direction to the clutch engaging force that is introducible into the clutch system, wherein the lever system has axial spring properties which cause the lever system to be pushed in the direction of a position in the shape of a truncated cone, which corresponds to the disengaged state of the friction clutch, where the lever system has a rising force-travel spring characteristic over the pivot distance needed to engage the friction clutch, and the spring means acting axially on the lever system produce a force-travel spring characteristic that decreases, at least in the working range over which the spring means are deformed to compensate at least partially for wear.

2: A clutch unit according to claim 1, wherein the lever system can pivot radially outside in the manner of a one-armed lever around a ring-shaped rolling contact support carried by the adjusting ring.

3: A clutch unit according to claim 1, wherein the adjusting ring is supported on the clutch housing through a ramp system provided in a ring-shaped arrangement.

4: A clutch unit according to claim 3, wherein the ramp system is stretched over at least one energy storage element in the sense of an axial wear adjustment system.

5: A clutch unit according to claim 1, wherein the lever system is acted on by the spring means indirectly or directly axially in the direction of a pivot support, radially within the adjusting ring that carries the pivot support.

6: A clutch unit according to claim 1, wherein the spring means include an element in the nature of a diaphragm spring, which is clamped operationally between the housing and the lever system.

7: A clutch unit according to claim 1, wherein the spring means include spring elements that are braced axially between the housing and the pressure disk.

8: A clutch unit according to claim 7, wherein the spring elements are formed by leaf springs.

9: A clutch unit according to claim 1, wherein a lining resiliency is present between the friction linings of the clutch plate.

10: A clutch unit according to claim 1, wherein when the pressure disk is in contact with the adjacent friction lining of the clutch plate, and when there is no wear of the friction linings, the axial forces acting on the lever system in the direction of engagement are at least approximately in equilibrium with the resulting spring force acting on the lever system contrary to the direction of engagement.

11: A clutch unit according to claim 10, wherein the resulting spring force is at least produced by at least one diaphragm-spring-like component clamped between the housing and the lever system, and in addition by leaf springs braced between the pressure disk and the housing, and if necessary by an axial support force produced as a result of the bracing of the pressure disk on the adjacent friction lining by the lining resiliency.

12: A clutch unit according to claim 1, wherein the wear compensation is accomplished by means of the adjusting device during a disengaging phase of the clutch unit.

13: A clutch unit according to claim 1, wherein the wear adjustment is accomplished by means of the adjusting device during a disengaging phase of the clutch unit, when the lining resiliency is at least approximately fully relaxed.
